(19) United States
(12) Patent Application Publication
(10) Pub. No.: US 2021/0245335 A1
(43) Pub. Date: Aug. 12, 2021

(54) SUBSTRATE HOLDING APPARATUS

(71) Applicant: Sakai Display Products Corporation, Osaka (JP)

(72) Inventor: Nobuhiro YONEZAWA, Osaka (JP)

(21) Appl. No.: 16/305,513

(22) PCT Filed: May 31, 2016
(86) PCT No.: PCT/JP2016/066033

§ 371 Date: Nov. 29, 2018

(51) Int. Cl. B25B 11/00; G02F 1/13

(52) U.S. Cl. CPC B25B 11/005; G02F 1/1303

(57) ABSTRACT

A substrate holding apparatus capable of curving a substrate without causing twisting is provided. A substrate holding apparatus for sucking and holding a substrate, includes a central frame equipped with a suction member for sucking the substrate, a pair of lateral frames disposed on both outer sides of the central frame so that the central frame is interposed between the pair of lateral frames, wherein each of the lateral frames is equipped with a suction member for sucking the substrate, and connecting parts for rotatably connecting the central frame and respective lateral frames around axes parallel to each other. Each of the lateral frames includes a sliding part slidable in a direction moving close to or away from the central frame, and each suction member equipped for each of the lateral frames is provided to the sliding part.

### TECHNICAL FIELD

The present invention relates to a substrate holding apparatus for sucking and holding a substrate.

### BACKGROUND ART

Display apparatuses such as liquid crystal display apparatuses and organic electro-luminescence (EL) display apparatuses are widely used for computer displays, television receivers, information displays for displaying various kinds of information, and the like. Further, curved screen display having a display surface curved into a convex or concave shape is already realized in the display apparatuses such as liquid crystal display apparatuses and organic EL display apparatuses.

The curved screen display can be installed in a space-saving fashion in various installation locations. For example, the curved screen display having a convex display surface can be wound around an outer circumferential surface of a circular column when it is installed. Further, the curved screen display having a concave display surface can be installed in a space-saving fashion at a corner of a room.

### PRIOR ART DOCUMENT

### Patent Document

Patent Document 1: JP 2010-8479 A

### SUMMARY OF THE INVENTION

### Problem to be Solved by the Invention

The above-mentioned curved screen display is usually manufactured by placing a flat display panel on a backlight chassis curved into a convex or concave shape and pressing the display panel from above to fix it to the backlight chassis.

However, there is a case where the curvature cannot be synchronized between an upper side and a lower side of the display panel depending on a pressing force during the pressing, and it is feared that the display panel may be twisted and broken.

The present invention has been made in view of such circumstances and aims to provide a substrate holding apparatus capable of curving a substrate without causing twisting.

### Means to Solve the Problem

According to one embodiment of the present invention, a substrate holding apparatus for sucking and holding a substrate comprises a central frame equipped with a suction member for sucking the substrate, a pair of lateral frames disposed on both outer sides of the central frame so that the central frame is interposed between the pair of lateral frames, wherein each of the lateral frames is equipped with a suction member for sucking the substrate, and connecting parts for rotatably connecting the central frame and respective lateral frames around axes parallel to each other, wherein each of the lateral frames includes a sliding part slidable in a direction moving close to or away from the central frame, and each suction member equipped for each of the lateral frames is provided to the sliding part.

### Effects of the Invention

According to the present application, it is possible to curve the substrate without causing any twisting.

### BRIEF DESCRIPTION OF THE DRAWINGS

FIG. 1 is a perspective view illustrating a schematic configuration of a substrate holding apparatus according to one embodiment.

FIG. 2 is a front view illustrating the schematic configuration of the substrate holding apparatus according to the embodiment.

FIG. 3 is a plan view illustrating the schematic configuration of the substrate holding apparatus according to the embodiment.

FIG. 4 is a schematic view illustrating an exemplary state of joined frame members.

FIG. 5 is a schematic view illustrating an exemplary state of an attached sliding frame.

FIG. 6 is a partly enlarged view illustrating an exemplary configuration of a driving mechanism.

FIG. 7 is a block diagram illustrating an exemplary configuration of a driving system for the substrate holding apparatus according to the embodiment.

FIG. 8 is a perspective view of the substrate holding apparatus in a state where the lateral frames are rotated.

FIG. 9 is a front view of the substrate holding apparatus in the state where the lateral frames are rotated.

FIG. 10 is a plan view of the substrate holding apparatus in the state where the lateral frames are rotated.

FIG. 11 illustrates an exemplary displacement of outer suction units according to the curving of a substrate.

### EMBODIMENT FOR CARRYING OUT THE INVENTION

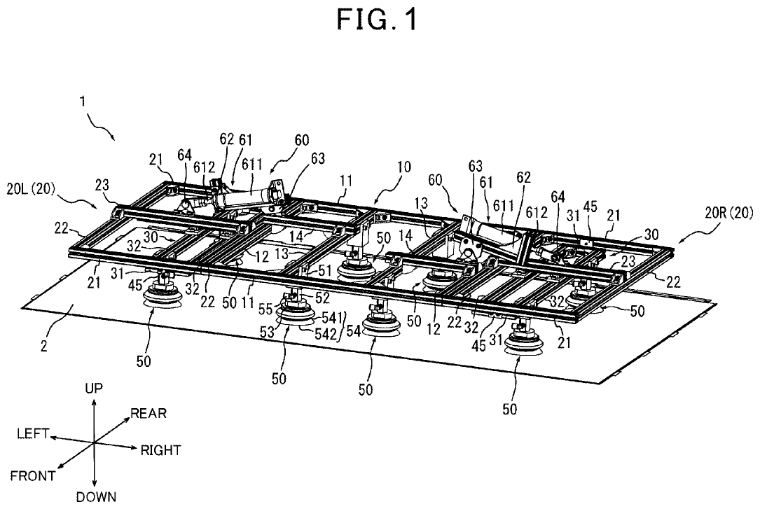

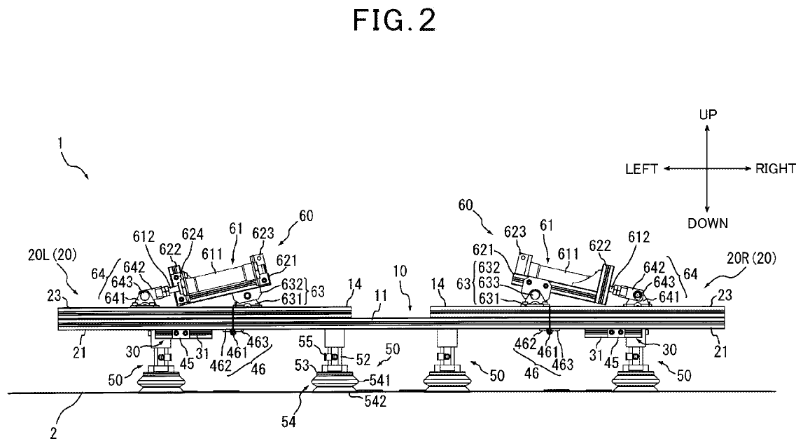

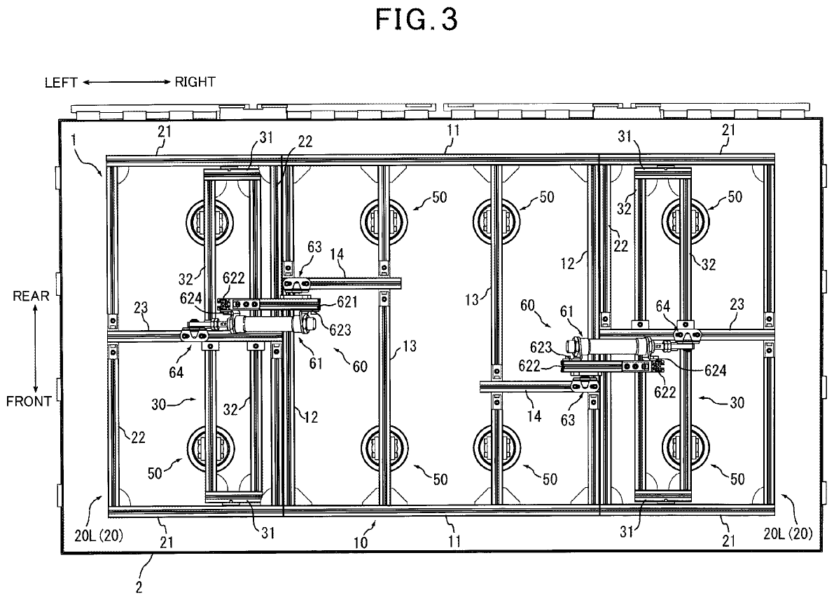

An embodiment of the present invention will be described in detail below with reference to attached drawings. FIG. 1 is a perspective view illustrating a schematic configuration of a substrate holding apparatus according to one embodiment, FIG. 2 is a front view of the substrate holding apparatus, and FIG. 3 is a plan view of the substrate holding apparatus. A substrate holding apparatus 1 according to the embodiment includes a mechanism for lifting up a rectangular flat substrate 2 such as a liquid crystal display panel in a state where the substrate 2 is sucked and held and for curving the substrate 2 in the lifted-up state. FIGS. 1 to 3 illustrate, as an exemplary state where the substrate 2 is sucked and held, a state immediately after completing the sucking of a display surface of the liquid crystal display panel (namely, a state of the liquid crystal display panel before it is curved). Hereinafter, an exemplary configuration of the substrate holding apparatus 1 will be described referring to up and down, right and left, and front and rear directions illustrated in the drawings.

The substrate holding apparatus 1 according to the embodiment includes a central frame 10 positioned at the center in the right and left direction, and lateral frames 20L, 20R each positioned on the left and right sides of the central frame 10 so that the central frame 10 is interposed therebetween. The lateral frame 20L is rotatably joined with the central frame 10, as described below. In the following description, if it is unnecessary to discriminate the lateral frame 20L positioned on the left with respect to the central frame 10 from the lateral frame 20R positioned on the right with respect to the central frame 10, the lateral frames 20L and 20R may be collectively referred to as the lateral frame(s) 20.

The central frame 10 is a rectangular frame whose size in a front and rear direction is slightly longer than that in a right and left direction. The central frame 10 is assembled by connecting a pair of frame members 11, 11 for front and rear short sides of the central frame 10 and a pair of frame members 12, 12 for right and left long sides of the central frame 10, and is formed in a lattice shape. The central frame 10 is not limited to the rectangular frame although described as the rectangular frame in the embodiment, and may be configured as a cross-shaped, H-shaped, or elliptically shaped frame when seen in plan view.

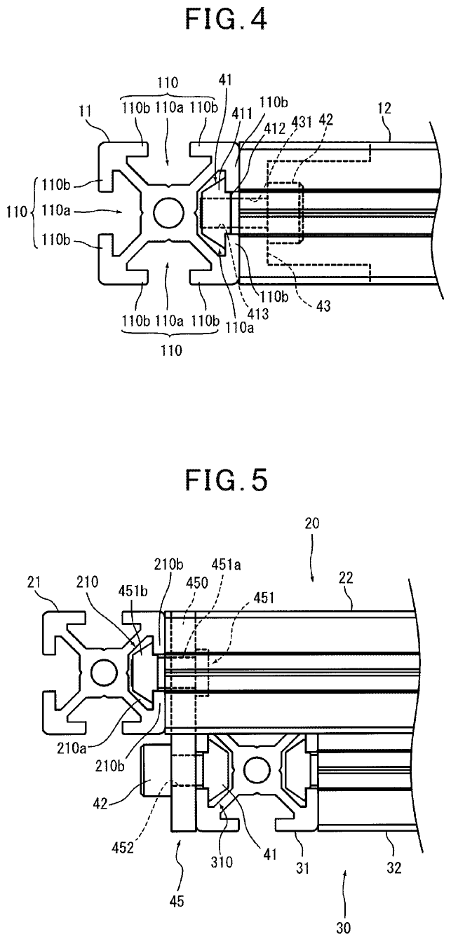

FIG. 4 is a schematic view illustrating an exemplary state of the frame members 11, 12 joined together. The frame members 11, 12 used for the short and long sides of the central frame 10 are aluminum members, for example, by extrusion molding. The frame member 11 for short side is substantially square in its cross section, and includes slide grooves 110. Each of the slide grooves 110 has a hollow portion 110a and opening ends 110b, 110b. The hollow portion 110a has a trapezoidal shape widened from the center of the cross section toward four sides of the frame member 11 and a connecting nut 41 can be slidably entered into the hollow portion 110a. The opening ends 110b, 110b equally protrudes from the left and the right so as to cover the upper surface of the hollow portion 110a. The frame member 12 for long side is similar to the frame member 11 for short side.

The frame members 11, 12 are joined by means of connecting nuts 41, connecting bolts 42, and metal attaching fittings 43. The connecting nut 41 has a plate part 411 having a cross-sectional shape slightly smaller that the cross-sectional shape of the slide groove 110, a convex part 412 having a width slightly narrower than the opening width between opening ends 110b, 110b and protruding in the thickness direction of the plate part 411, and a screw hole 413 into which the connecting nut can be screwed. The attaching fitting 43 has an L-shaped external configuration constituted by rectangular plate members substantially perpendicularly connected, and an insertion hole 431 for insertion of a screw part of the connecting bolt is provided on each plate member.

When joining the frame members 11, 12, the connecting nut 41 is inserted into the slide groove 110 of one frame member 11 and the connecting nut 41 is slid to perform positioning for attachment. Then, a side surface of one plate member constituting the attaching fitting 43 is brought into contact with an attaching surface of the frame member 11, and the screw part of the connecting bolt 42 is inserted into the insertion hole 431 of the attaching fitting 43 and screwed and fixed into the screw hole 413 of the connecting nut 41. Through the above-mentioned processes, in a state where the convex part 412 of the connecting nut 41 is fitted in an opening formed by the opening ends 110b, 110b of the frame member 11, a structure such that the opening ends 110b, 110b and the attaching fitting 43 are sandwiched between the connecting nut 41 and the connecting bolt 42 is constituted. Next, another connecting nut 41 is inserted into the slide groove of the other frame member 12, and the connecting nut 41 is slid to perform positioning for attachment. Then, a side surface of the other plate member constituting the attaching fitting 43 is brought into contact with an attaching surface of the other frame member 12, and the screw part of the connecting bolt 42 is inserted into the insertion hole of the attaching fitting 43 and screwed and fixed into the screw hole 413 of the connecting nut 41. By performing such connection using connecting nuts 41, connecting bolts 42, and attaching fittings 43 at various places, the central frame illustrated in FIGS. 1 to 3 can be assembled.

The central frame 10 includes reinforcing frames 13, 13 disposed at equal intervals in the right and left direction, between the pair of frame members 12, 12 for right and left sides. The reinforcing frame 13 is substantially square in its cross section, which is similar to that described above, and is constituted by a frame member having a slide groove extending in the longitudinal direction on each side surface. The reinforcing frames 13 connects the pair of frame members 11, 11 for front and rear sides, using connecting nuts 41, connecting bolts 42, and attaching fittings 43.

Further, transverse frames 14, 14 horizontally extending in the right and left direction are provided on the upper surface of the central frame 10. The transverse frame 14 is substantially square in its cross section, which is similar to that described above, and is constituted by a frame member having a slide groove extending in the longitudinal direction on each side surface. The transverse frame 14 has a length comparable to approximately ⅓ of the frame member 11 for short side, and is connected to an upper surface of the reinforcing frame 13 and an upper surface of the frame member 12 for long side by means of connecting nuts 41, connecting bolts 42, and attaching fittings 43. With respect to the point for connection, one of the transverse frames 14, 14 is closer to the front with respect to the center in the front and rear direction, and the other is closer to the rear with respect to the center in the front and rear direction.

The central frame 10 includes suction units 50 attached to the reinforcing frames 13. In the embodiment, two suction units 50, 50 are provided for each reinforcing frame 13. Accordingly, the central frame 10 is configured to suck the substrate 2 at two positions in the front and rear direction and at two positions in the right and left direction (in the short direction and in the longitudinal direction of the substrate 2 according to the example illustrated in FIG. 1).

The suction unit 50 includes a connection part 51 to be connected to the reinforcing frame 13, a columnar part 52 having an air drawing passage (not illustrated) provided therein, a pedestal part 53 provided with a hollow portion communicating with the air drawing passage, and a pad part 54 attached to the pedestal part 53.

The connection part 51 is a rectangular parallelepiped member having an upper surface on which a rectangular groove having a width slightly wider than the width of the reinforcing frame 13 is provided. Two insertion holes are provided on both sides of the connection part 51 with the groove interposed therebetween. When attaching the suction unit 50 to the reinforcing frame 13, two connecting nuts 41 are inserted into slide grooves provided on a left side surface and a right side surface of the reinforcing frame 13, and the connecting nuts 41 are slid to perform positioning for mounting of the suction unit 50 with respect to the reinforcing frame 13. Then, the reinforcing frame 13 is disposed in the groove of the connection part 51, and the screw part of the connecting bolt 42 is inserted into the insertion hole and screwed and fixed to the screw hole 413 of the connecting nut 41. By performing such connection using connecting nuts 41 and connecting bolts 42 at each connecting place, two suction units 50 are attached to each reinforcing frame 13. The number of the suction units 50 and their mounting positions can be appropriately changed in consideration of dimensions of the substrate 2 to be sucked and held, flexibility of the substrate 2, substrate weight, and the like.

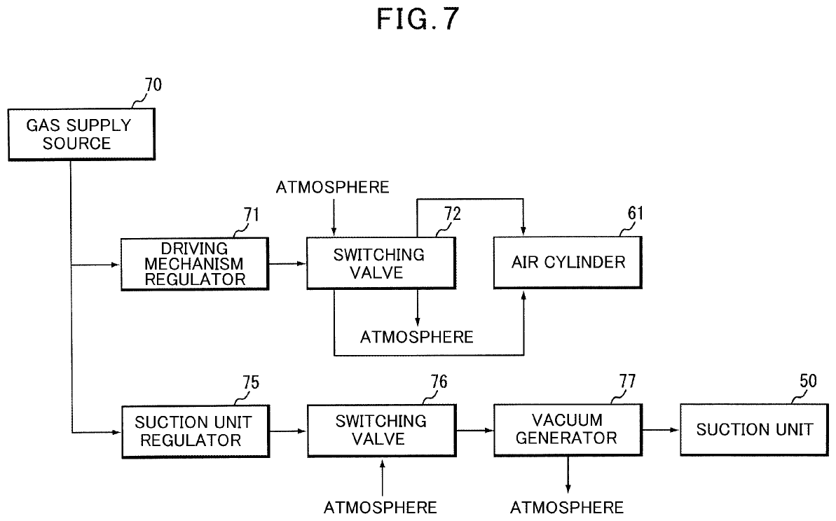

The columnar part 52 of the suction unit 50 is provided at the lower end of the connection part 51, and is a prismatic or columnar member having the air drawing passage provided therein. A screw hole is provided on a side surface of the columnar part 52. The screw hole is communicating with the air drawing passage, and a connection plug 55 for vacuum piping is screwed to the screw hole. Via the connection plug 55 screwed into the screw hole, the suction unit 50 and a vacuum generator 77 (see FIG. 7) can be connected using vacuum piping (not illustrated).

The pedestal part 53 is, for example, a cylindrical member, and includes a hollow portion (not illustrated) communicating with the air drawing passage of the columnar part 52. The pad part 54 is attached to the lower end of the pedestal part 53. The pad part 54 is a bellows type suction pad. The pad part 54 has a bellows portion 541 formed of a synthetic resin, such as nitrile rubber, silicone rubber, fluororubber, or the like, and having a hollow shape, and has a suction surface 542 provided at the lower end of the bellows portion 541. After bringing the suction surface 542 of the pad part 54 into contact with an upper surface of the substrate 2 to be sucked, the vacuum generator 77 depressurizes the space surrounded by the bellows portion 541, thereby causing the suction unit 50 to suck and hold the substrate 2. Further, the pad part 54 is configured to be deformable in such a way as to follow the curving of the substrate 2 being sucked and held.

The lateral frame 20 positioned on each of the left and right with respect to the central frame 10 is a rectangular frame whose size in the front and rear direction is longer than that in the right and left direction. The lateral frame 20 is assembled by connecting a pair of frame members 21, 21 for front and rear short sides and a pair of frame members 22, 22 for right and left long sides, and is formed in a lattice shape. Each of the frame members 21, 22 constituting the lateral frame 20 is substantially square in its cross section, like those of the central frame 10, and includes a slide groove extending in the longitudinal direction of the frame member on each side surface. Further, the frame member 22 for long side of the lateral frame 20 has the same length as the frame member 12 for long side of the central frame 10. The lateral frame 20 can be assembled by joining the frame members 21, 21 for short sides and the frame members 22, 22 for long sides and using connecting nuts 41, connecting bolts 42, and attaching fittings 43.

A transverse frame 23 horizontally extending in the right and left direction is provided on the upper surface of the lateral frame 20. Similar to the frame members 21, 22 constituting the lateral frame 20, the transverse frame 23 is substantially square in its cross section and is constituted by a frame member having slide groove extending in the longitudinal direction on each side surface. The transverse frame 23 has substantially the same length as the frame member 21 for short side of the lateral frame 20, and have both ends connected to substantially the centers of respective frame members 22, 22 for long sides. For joining the frame members 22, 22 for long sides, connecting nuts 41, connecting bolts 42, and attaching fittings 43 are used.

The lateral frame 20 includes a sliding frame 30 provided slidably in the longitudinal direction of the frame member 21 for short side. The sliding frame 30 is a rectangular frame assembled by connecting a pair of frame members 31, 31 for front and rear sides and a pair of frame members 32, 32 for right and left sides, and is formed in a lattice shape. The pair of frame members 31, 31 for front and rear sides has a length corresponding to approximately ⅓ of the lateral frame 20 for short side. The pair of frame members 32, 32 for right and left sides is slightly shorter than the long side of the lateral frame 20.

The sliding frame 30 is slidably attached to the lateral frame 20 via mounting plates 45. FIG. 5 is a schematic view illustrating a state of the sliding frame 30 attached. The mounting plate 45 is configured by a rectangular plate body 450 including a sliding pin 451 that slides in a hollow portion 210a of the slide groove 210 of the frame member 21 and an insertion hole 452 into which the screw part of the connecting bolt is inserted. The plate body 450 has a height comparable to two times the height of the frame member 21 and an appropriate width. Further, the thickness of the plate body 450 is slightly smaller than a gap formed between an inner surface of the lateral frame 20 and an outer surface of the sliding frame 30. The sliding pin 451 has a columnar shaft 451a protruding in the thickness direction of the plate body 450 at a position close to the upper end of the plate body 450 and a sliding piece 451b formed at a protruding end of the shaft 451a. The shaft 451a has a diameter slightly smaller than the opening width between opening ends 210b and 210b of the slide groove 210 of the frame member 21. The sliding piece 451b has a cross-sectional shape slightly smaller than the cross-sectional shape of the slide groove 210.

When attaching the sliding frame 30 to the lateral frame 20, the sliding piece 451b of the mounting plate 45 is fitted into the slide groove 210 of the frame member 21, and the mounting plate 45 is fixed to the sliding frame 30 using a connecting nut 41 and a connecting bolt 42. The fixing of the mounting plate 45 to the sliding frame 30 is performed by inserting the connecting nut 41 into a slide groove 310 of the frame member 31 of the sliding frame 30 and screwing the connecting bolt 42 with the connecting nut 41. In the state where the sliding frame 30 is attached to the lateral frame 20, an inner surface of the frame member 21 constituting the lateral frame 20 faces one surface of the mounting plate 45 in an upper region of the mounting plate 45 and an outer surface of the frame member 31 constituting the sliding frame 30 is in contact with the other surface of the mounting plate 45 in a lower region of the mounting plate 45. In addition to the mounting plate 45, the sliding frame 30 may be attached to the lateral frame 20 via a guide rail provided on the lower surface of the transverse frame 23. In this case, a guide plate having a groove slidably coupled with the guide rail is provided at the center of each frame member 32 in the longitudinal direction.

The lateral frame 20 is equipped with the suction units 50 attached to the sliding frame 30. In the embodiment, two suction units 50, 50 are attached to one of the frame members 32 for long side of the sliding frame 30. Therefore, the lateral frame 20 is configured to suck the substrate 2 at two places in the front and rear direction (the short direction of the substrate according to the example illustrated in FIG. 1). The suction units 50 equipped for the lateral frame 20 are similar to the suction units 50 equipped for the central frame 10. The suction units 50 can be fixed to the frame member 32 using connecting nuts 41 and connecting bolts 42 after the frame member 32 is disposed in the groove of the connection part 51 of the suction unit 50. The number of the suction units 50 and their mounting positions can be appropriately changed in consideration of dimensions of the substrate 2 to be sucked and held, flexibility of the substrate 2, substrate weight, and the like.

The lateral frame 20 is rotatably joined with the central frame 10. For example, the frame member 12 for long side of the central frame 10 and a neighboring frame member 22 for long side of the lateral frame 20 are connected by hinges 46 at their lower surfaces so that the lateral frame 20 is rotatable with respect to the central frame 10.

The hinge 46 includes a shaft 461, a butterfly piece 462 rotatably connected to the central portion of the shaft 461 in the axial direction, and a butterfly piece 463 rotatably connected to both ends of the shaft 461 in the axial direction. The hinge 46 is disposed in such a manner that the longitudinal directions of the frame members 12, 22 become parallel to the shaft 461 of the hinge 46, in a state where the outer surface of the frame member 12 for long side of the central frame 10 is in contact with the outer surface of the frame member 22 for long side of the lateral frame 20. Then, the one butterfly piece 462 is fixed to the lower surface of the frame member 12 of the central frame 10 and the other butterfly piece 463 is fixed to the lower surface of the frame member 22 of the lateral frame 20, thereby rotatably joining the frame members 12, 22. The fixing using the hinge 46 on respective frame members 12, 22 is performed at a plurality of places (e.g., three places) in the longitudinal direction. With the above-mentioned configuration, the lateral frames 20, 20 are rotatably connected by the hinges 46 around the axis parallel to the longitudinal directions of the frame members 12, 12 of the central frame 10 (namely, around axes parallel to each other).

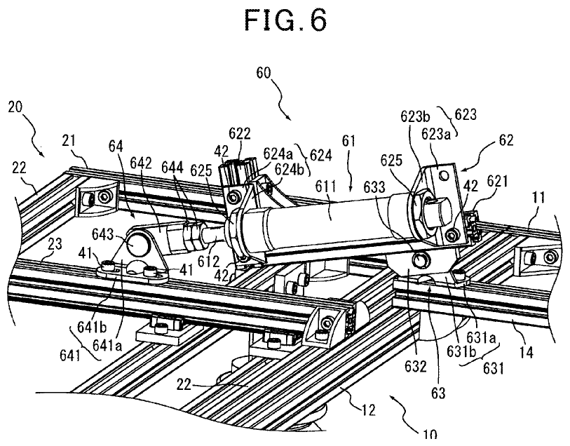

Further, the substrate holding apparatus 1 according to the embodiment includes a pneumatic driving mechanism 60 for rotating the lateral frame 20 with respect to the central frame 10. FIG. 6 is a partly enlarged view illustrating an exemplary configuration of the driving mechanism 60. For example, the driving mechanism 60 includes an air cylinder 61, an air cylinder holder 62 for holding the air cylinder 61, a joint 63 for connecting one end of the air cylinder 61 to the central frame 10 via the air cylinder holder 62, and a joint 64 for connecting the other end of the air cylinder 61 to the lateral frame 20.

The air cylinder 61 is, for example, a double acting cylinder, which includes a cylindrical cylinder body 611 having two gas chambers formed therein, and a piston rod 612 advancing and retracting with respect to the cylinder body 611. When gas is supplied to pressurize one of the two gas chambers of the cylinder body 611 (and depressurize the other), the piston rod 612 moves in a direction protruding out of the cylinder body 611 and the air cylinder 61 extends correspondingly. Further, when gas is supplied to pressurize the other gas chamber (and depressurize the former one), the piston rod 612 moves in a direction retracting into the cylinder body 611 and the air cylinder 61 contracts correspondingly.

The cylinder holder 62 includes a frame member 621 which is slightly longer than the cylinder body 611 and is disposed along the longitudinal direction of the cylinder body 611, a frame member 622 connected in a direction orthogonal to the frame member 621, a retainer 623 for holding one end of the cylinder body 611, and a retainer 624 for holding the other end of the cylinder body 611. The frame members 621, 622 are similar to the frame members 11 of the central frame 10 and the like and are substantially square in their cross sections, and include slide grooves on respective side surfaces extending in the longitudinal direction. The frame members 621, 622 are connected so as to be orthogonal to each other using connecting nuts 41, connecting bolts 42, and attaching fittings 43. The retainer 623 (624) is a metal plate member having a substantially L shape in plan view and a substantially triangular shape in side view, and includes a rectangular attaching piece 623a (624a) having an insertion hole for a connecting bolt and a rectangular holding piece 623b (624b) having an insertion hole for the cylinder body. The retainer 623, 624 are disposed in such a manner that their insertion holes for the cylinder body are opposed to each other. The one retainer 623 is connected to an end of the frame member 621 using the connecting bolt 42 so as to be orthogonal to the frame member 621. The other retainer 624 is connected along the frame member 622 using the connecting bolt 42. The retainer 623 and 624 are positioned in such a manner that both ends of the cylinder body 611 protrude outward from the retainers 623, 624 when they holds the cylinder body 611, and are subsequently connected to the frame members 621, 622. Screw grooves (not illustrated) are provided at both ends of the cylinder body 611. The air cylinder 61 is fixed to the air cylinder holder 62 by screwing connecting nuts 625, 625 into these screw grooves from the outside of the retainers 623, 624.

The joint 63 includes a central frame side metal fitting 631 to be fixed to the transverse frame 14 provided to the central frame 10 and a cylinder side metal fitting 632 to be fixed to the air cylinder holder 62. The central frame side metal fitting 631 is a metal plate member having a substantially triangular shape in front view and a substantially L shape in side view, and includes a rectangular attaching piece 631a having an insertion hole for a connecting bolt and a rectangular support piece 631b having an insertion hole for insertion of a support pin 633. The central frame side metal fitting 631 is connected to an end of the transverse frame 14 constituting the central frame 10 using the connecting bolt 42 or the like. The cylinder side metal fitting 632 is a metal plate member having a rectangular shape, and includes an insertion hole for insertion of the support pin 633 and an insertion hole for a connecting bolt. The cylinder side metal fitting 632 is rotatably supported with respect to the central frame side metal fitting 631 by the support pin 633, and is connected to the frame member 621 of the air cylinder holder 62 using a connecting bolt or the like.

The joint 64 includes a lateral frame side metal fitting 641 fixed to the transverse frame 23 of the lateral frame 20 and a fixture 642 fixed to a tip end of the piston rod 612. The lateral frame side metal fitting 641 is a metal plate member having a substantially triangular shape in front view and a substantially L shape in side view, and includes a rectangular attaching piece 641a having an insertion hole for a connecting bolt and a rectangular support piece 641b having an insertion hole for a support pin 643. The lateral frame side metal fitting 641 is connected to substantially the center of the transverse frame 23 of the lateral frame 20 by means of a connecting bolt 42 or the like. The fixture 642 has a columnar housing, and includes a fixing hole for the piston rod 612 provided on a side surface of the housing, and an insertion hole for the support pin 633 provided on the side surface of the housing. The fixture 642 fixes the tip end of the piston rod 612 to the inside of the fixing hole by means of nuts 644 or the like, and is rotatably supported with respect to the lateral frame side metal fitting 641 by the support pin 643.

In the embodiment, the air cylinder 61 is connected to the central frame 10 and the lateral frame 20 via the joints 63, 64 in an inclined state so that the central frame 10 side is high and the lateral frame 20 side is low in a state where the air cylinder 61 is contracted. Further, in this state, the lateral frames 20 are continuous to the central frame 10 substantially in parallel. More specifically, the inclination of each lateral frame 20 relative to the central frame 10 is 0 degree. The outer surface of the one frame member 22 of the lateral frame 20 and the outer surface of the one frame member 12 of the central frame 10 come into contact with each other.

In the embodiment, by causing the air cylinder 61 to extend, it is possible to rotate the lateral frame 20 downward around the shaft 461 of the hinge 46 serving as the center of rotation. More specifically, it is possible to incline the lateral frame 20 with respect to the central frame 10. FIG. 7 is a block diagram illustrating an exemplary configuration of a driving system for the substrate holding apparatus 1 according to the embodiment. The substrate holding apparatus 1 includes a driving mechanism regulator 71 connected to a gas supply source 70, and a switching valve 72, in order to drive the air cylinder 61. The gas supply source 70 is, for example, compressed air used in factory, compressor, or the like, and is configured to supply a gas such as dry air or nitrogen gas to the driving mechanism regulator 71 and a suction unit regulator 75 described below.

The driving mechanism regulator 71 is connected between the gas supply source 70 and the switching valve 72, and is configured to adjust the pressure of the gas supplied from the gas supply source 70 and supply the pressure adjusted gas via the switching valve 72 to the air cylinder 61. The air cylinder 61 is a double acting cylinder. When one of the two gas chambers of the cylinder body 611 is pressurized (the other is depressurized) by the gas supplied through the switching valve 72, the piston rod 612 moves in a direction protruding out of the cylinder body 611 and the air cylinder 61 extends correspondingly. Further, when the other of the two gas chambers is pressurized (the one is depressurized) by the gas supplied through the switching valve 72, the piston rod 612 moves in a direction retracting into the cylinder body 611 and the air cylinder 61 contracts correspondingly. The extension/contraction control of the piston rod 612 is performed by a control apparatus (not illustrated) configured to control an electromagnetic valve of the switching valve 72.

The substrate holding apparatus 1 further includes the suction unit regulator 75 connected to the gas supply source 70, a switching valve 76, and the vacuum generator 77 in order to drive the suction unit 50. The suction unit regulator 75 is connected between the gas supply source 70 and the switching valve 76, and is configured to adjust the pressure of the gas supplied from the gas supply source 70 and supply the pressure adjusted gas via the switching valve 76 and the vacuum generator 77 to the suction unit 50.

When sucking and holding the substrate 2 with the suction unit 50, an exhaust valve of the switching valve 76 is closed and the vacuum generator 77 is activated to depressurize the space surrounded by the pad part 54 of the suction unit 50 and the substrate 2. Further, when terminating the sucking by the suction unit 50, the vacuum generator 77 is deactivated and the exhaust valve of the switching valve 76 is opened, and the gas supplied through the suction unit regulator 75 is fed to an internal space of the pad part 5 for control to return to the atmospheric pressure. The suction control by the suction unit 50 can be performed by the control apparatus (not illustrated) configured to control the exhaust valve of the switching valve 76 and the operational state of the vacuum generator 77.

The above-mentioned control apparatus may be configured to control all of the suction units 50 (eight pieces according to the example illustrated in FIG. 1) equipped for the substrate holding apparatus 1, by controlling the switching valve 76 and the vacuum generator 77. Alternatively, the suction units 50 may be divided into a plurality of groups and each group includes the switching valve 76 and the vacuum generator 77 so that the control apparatus can perform suction control for each group.

Hereinafter, an exemplary state of the lateral frames 20 rotated with respect to the central frame 10 from the state illustrated in FIGS. 1 to 3 (namely, the lift-up state in which the substrate 2 sucked and held by the substrate holding apparatus 1 is kept in a horizontal state) will be described.

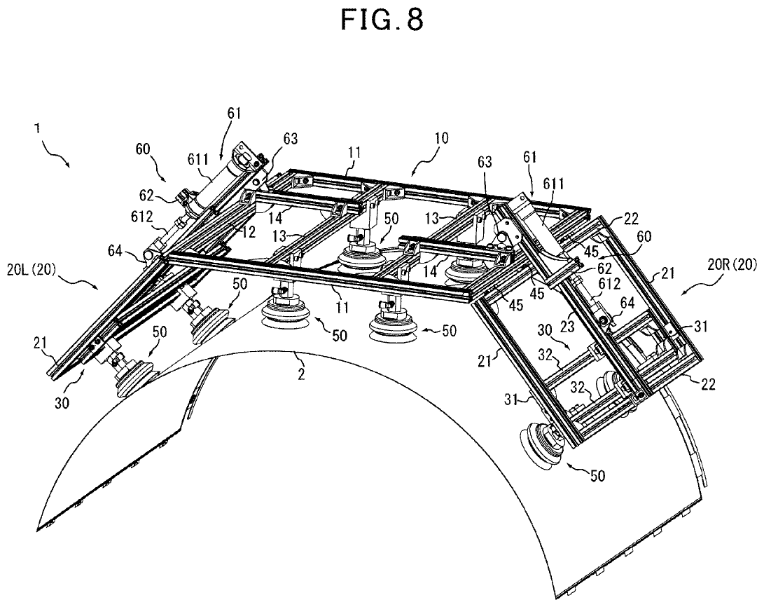

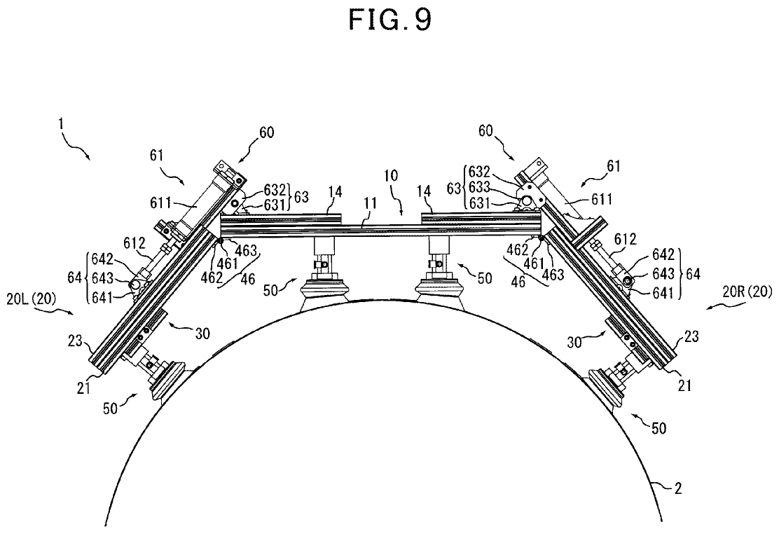

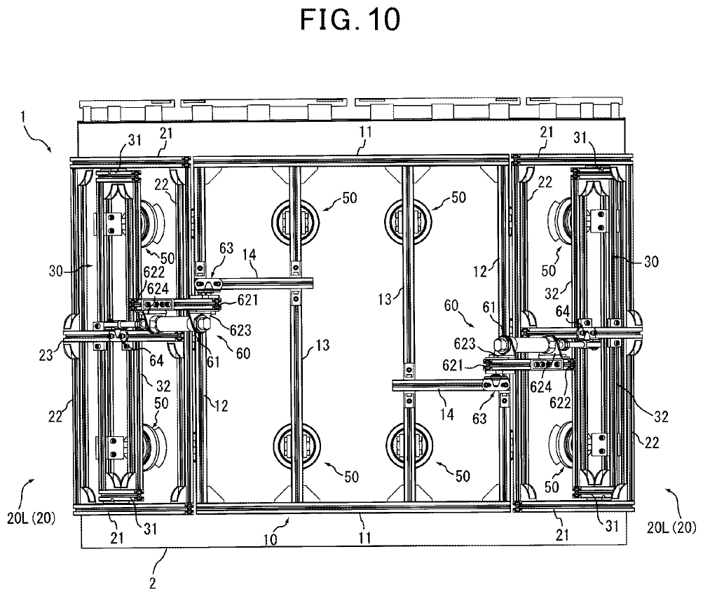

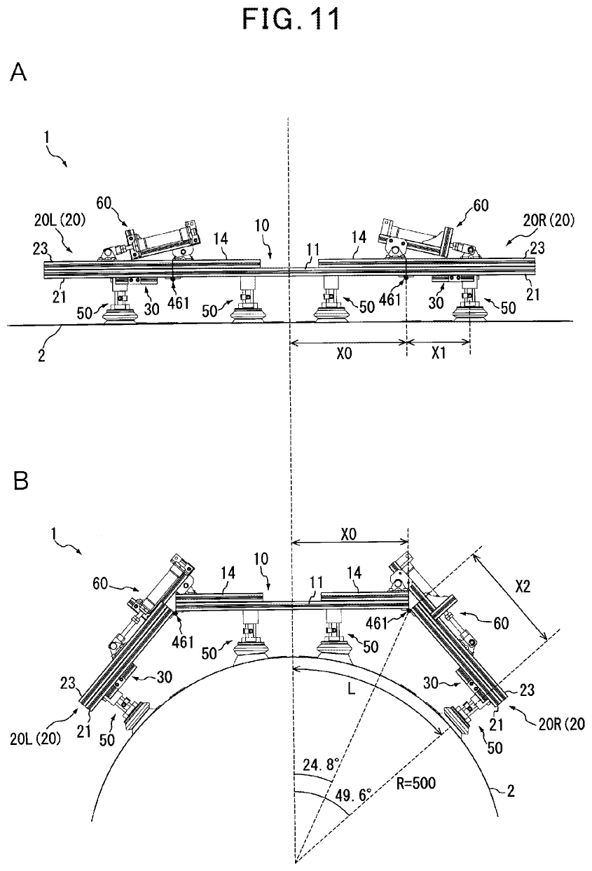

FIG. 8 is a perspective view illustrating the substrate holding apparatus 1 in a state where the lateral frames 20 are rotated. FIG. 9 is a front view of the substrate holding apparatus 1 in this state, and FIG. 10 is a corresponding plan view. FIGS. 8 to 10 illustrate a state where the lateral frames 20 are rotated by causing the air cylinder 61 to extend after the substrate 2 sucked and held by the suction units 50 equipped for the central frame 10 and the lateral frames 20 has been lifted up.

When the air cylinder 61 extends, the relative angle between the central frame side metal fitting 631 and the cylinder side metal fitting 632 at the joint 63 changes and the relative angle between the lateral frame side metal fitting 641 and the fixture 642 at the joint 64 changes, while the central frame 10 is held in a substantially horizontal state, thereby causing the lateral frame 20 to rotate downward. In this state, the angle of the air cylinder 61 relative to the transverse frame 23 becomes smaller according to the rotation of the lateral frame 20. FIG. 9 illustrates a state where the angle of the air cylinder 61 relative to the transverse frame 23 is substantially 0, namely the longitudinal direction of the transverse frame 23 is substantially parallel to a cylinder axis of the air cylinder 61.

The substrate 2 sucked and held by the suction units 50 is gradually curved into an arc shape according to the rotation of the lateral frames 20. Further, since the suction units 50 equipped for the lateral frames 20 (hereinafter, referred to as outer suction units 50) are provided to the sliding frames 30, they can move together with the sliding frames 30 in a direction moving away from the central frame 10 according to the curving of the substrate 2. FIG. 11 illustrates an exemplary displacement of the outer suction units 50 according to the curving of the substrate 2. FIG. 11A illustrates a state where the substrate 2 is sucked and held horizontally by the substrate holding apparatus 1. In this state, the horizontal distance from the center of the central frame 10 in the horizontal direction to the rotation center of the lateral frame 20 (the shaft 461 of the hinge 46) is referred to as X0, and the horizontal distance from the rotation center of the lateral frame 20 to the central axis of the outer suction unit 50 is referred to as X1.

FIG. 11B illustrates the substrate 2 in a curved state. It is assumed that the substrate 2 forms an arc having a curvature of R500 and the central axis of the outer suction unit 50 has an inclination of 49.6 degrees relative to the vertical direction. In this state, perimeter L illustrated in FIG. 11B is L=2×π×500×49.6/360=432.8 mm. Since the sucking position of the suction unit 50 on the substrate 2 does not change, L=X0+X1.

Further, when the substrate 2 is curved into an arc shape, it is assumed that the outer suction unit 50 has moved to a position where a distance X2 from the rotation center of the lateral frame 20 to the central axis of the outer suction unit 50 is equal to X0. If X0=X2=280.5 mm, then X2−X1=128.2 (=280.5−152.3) mm because X1=L−X0=152.3 (=423.8−280.5) mm. More specifically, according to the example illustrated in FIG. 11, it is understood that the outer suction unit 50 has moved 128.2 mm in the direction moving away from the central frame 10 together with the sliding frame 30 according to the curving of the substrate 2. The moving distance of the outer suction unit 50 is variable depending on the positional relationship between the lateral frame 20 and the outer suction unit 50 when sucking the substrate 2, the movable range of the sliding frame 30, and the curved state of the substrate 2, and is not limited to the example illustrated in FIG. 11.

As mentioned above, in the substrate holding apparatus 1 according to the embodiment, the substrate 2 may be sucked and held with the suction units 50 equipped for the central frame 10 and the suction units 50 equipped for the lateral frame 20, and the substrate 2 is curved by rotating the lateral frames 20, 20 around the axes parallel to the longitudinal directions of the frame members 12, 12 for short side of the central frame 10 (namely, axes parallel to each other). Therefore, the occurrence of twisting when curving the substrate 2 can be suppressed.

The above-mentioned embodiment is a mere example in all respects and should be considered to be not restrictive. The scope of the present invention is indicated by the claims, not by the above-mentioned meaning, and intends to encompass all modifications within meaning and range equivalent to the claims.

The following is additionally disclosed in regard to the above embodiment.

The substrate holding apparatus of the embodiment is a substrate holding apparatus for sucking and holding a substrate including a central frame equipped with a suction member for sucking the substrate, a pair of lateral frames disposed on both outer sides of the central frame so that the central frame is interposed between the pair of lateral frames, wherein each of the lateral frames is equipped with a suction member for sucking the substrate, and connecting parts for rotatably connecting the central frame and respective lateral frames around axes parallel to each other, wherein each of the lateral frames includes a sliding part slidable in a direction moving close to or away from the central frame, and each suction member equipped for each of the lateral frames is provided to the sliding part.

In the embodiment of the substrate holding apparatus, the sliding part slides in a direction moving away from the central frame according to the curving of the substrate sucked by suction members equipped for the central frame and the lateral frames.

In the embodiment, the substrate holding apparatus includes a rotation mechanism for rotating the lateral frames around each of the axes.

In the embodiment of the substrate holding apparatus, the rotation mechanism includes a cylinder having a rod movable in an axial direction and a cylinder body housing the rod so as to advance and retract, a central frame joint rotatably connecting the cylinder body to the central frame, and a lateral frame joint rotatably connecting the rod to each of the lateral frames.

In the embodiment of the substrate holding apparatus, each of suction members is a bellows type suction pad.

### REFERENCE SIGNS LIST

1 substrate holding apparatus 2 substrate
10 central frame
11 frame member for short side
11 frame member for long side
20L, 20R lateral frame
30 sliding frame (sliding part)
46 hinge (connecting part)
50 suction unit (suction member)
60 driving mechanism (rotation mechanism)
61 air cylinder
63 joint
64 joint

1. A substrate holding apparatus for sucking and holding a substrate, comprising:
a central frame equipped with a central suction member for sucking the substrate;
a first lateral frames and a second lateral frame disposed on both outer sides of the central frame so that the central frame is interposed between the first lateral frame and the second lateral frames, wherein the first lateral frame is equipped with a first lateral suction member for sucking the substrate and the second lateral frame is equipped with a second lateral suction member for sucking the substrate; and
a first connecting parts for rotatably connecting the central frame and the first lateral frames around a first axis; and
a second connecting part for rotatably connecting the central frame and the second lateral frame around a second axis parallel to the first axis,
wherein the first lateral frames includes a first sliding part slidable in a direction moving close to or away from the central frame, and the second lateral frame includes a second sliding part slidable in a direction moving close to or away from the central frame, and
the first lateral suction member is provided to the first sliding part, and the second lateral suction member is provided to the second sliding part.

2. The substrate holding apparatus according to claim 1, wherein the first sliding part and the second sliding part slides in a direction moving away from the central frame according to the curving of the substrate sucked by the central suction member, the first suction member and the second suction member.

3. The substrate holding apparatus according to claim 1, further comprising:
a rotation mechanism for rotating the first lateral frame and the second lateral frames around the first axis and the second axis, respectively.

4. The substrate holding apparatus according to claim 3, wherein
the rotation mechanism includes,
a first cylinder having a first rod and a first cylinder body housing the first rod so as to advance and retract,
a second cylinder having a second rod and a second cylinder body housing the second rod so as to advance and retract,
a first central frame joint rotatably connecting the first cylinder body to the central frame,
a second central frame joint rotatably connecting the second cylinder body to the central frame,
a first lateral frame joint rotatably connecting the first rod to the first lateral frame, and
a second lateral frame joint rotatably connecting the second rod to the second lateral frame.

5. The substrate holding apparatus according to claim 1, wherein each of the central suction member, the first lateral suction member and the second lateral suction member is a bellows type suction pad.
